(19) United States
(12) Patent Application Publication
(10) Pub. No.: US 2012/0311021 A1
(43) Pub. Date: Dec. 6, 2012

(54) PROCESSING METHOD OF TRANSACTION-BASED SYSTEM

(75) Inventors: Ming-Sheng Zhu, Tianjin (CN); Chih-Feng Chen, Taipei (TW)

(73) Assignee: INVENTEC CORPORATION, Taipei (TW)

(21) Appl. No.: 13/242,224

(22) Filed: Sep. 23, 2011

(30) Foreign Application Priority Data
Jun. 1, 2011 (CN) 201110157697.X

(51) Int. Cl. G06F 15/16; G06F 12/08

(52) U.S. Cl. 709/203; 711/144; 711/E12.026

(57) ABSTRACT

A method of a transaction-based system is applicable to a data deduplication system. In the system, pointers of same data point to a same position, so that when one piece of data is changed, all associated pointers need to be changed. In this method, a server first sets a flag to a false value, and after the server receives a request for backing up a data element from a client, the server reads a fingerprinting of the data element and determines whether the fingerprinting is the same as a temporary fingerprinting in a meta cache of the client, writes the data element and the fingerprinting into a corresponding temporary storage data block when the fingerprinting is not the same as the temporary fingerprinting, and writes the data element and the fingerprinting into a main meta cache and resets the flag when the flag is a true value.

### CROSS-REFERENCE TO RELATED APPLICATIONS

This non-provisional application claims priority under 35 U.S.C. §119(a) on Patent Application No(s). 201110157697.X filed in China, P.R.C. on Jun. 1, 2011, the entire contents of which are hereby incorporated by reference.

### BACKGROUND OF THE INVENTION

1. Field of the Invention

The disclosure relates to a processing method of data transmission, and more particularly to a processing method of a transaction-based system.

2. Related Art

With the development of science and technology, more and more companies rely on construction of a plurality of databases to carry out business or management of the company. These databases are associated and transfer data with each other to maintain consistency of the databases. However, once the databases suffer from power outage or virus attacks which render the databases irrecoverable, internal data of the company is often chaotic or lost, seriously affecting operation of the entire company. Therefore, database backup is of great importance for enterprises.

A database for maintaining operation is very large. Therefore, the backing up of the database should be performed in a fixed period. Moreover, multiple databases of an enterprise often include many data duplications due to overlapping services and the like. Therefore, during backup, a large data volume occupies great hardware space, thereby increasing the cost of the backup.

In order to save great hard disk space occupied when the data is backed up, a data deduplication system is then developed in the industry. The method is capable of dividing a file into a plurality of data blocks. After a comparison procedure, when the data blocks are identical to data blocks that are already backed up, the system only stores a pointer pointing to the file that is already backed up. Through such a method, the resources wasted due to data replication during backup can be saved, which reduces the hard disk space required for data backup.

However, during a processing procedure of the data deduplication system, when data of one of the data blocks needs to be changed, other pointers and content pointing to the data block also need to be changed. As a result, this method increases the processing load of a Central Processing Unit (CPU) and a memory, and requires longer time for backing up data. Therefore, it is necessary in this field to provide a method capable of reducing the processing load of the CPU and the memory and speeding up the backup when being executed by the data deduplication system.

### SUMMARY OF THE INVENTION

Accordingly, the disclosure is a method capable of reducing the processing load of the CPU and the memory in the data deduplication system, thereby reducing time required for backing up data.

In an embodiment of the disclosure, a server first sets a flag to a false value, and after the server receives a request for backing up a data element from multiple clients, the server reads a fingerprinting of the data element. The server determines whether the fingerprinting is the same as a temporary fingerprinting in a meta cache corresponding to the client, and when the fingerprinting is not the same as the temporary fingerprinting, the server writes the data element and the fingerprinting into a temporary storage data block corresponding to the data element. After that, the server determines whether a value of the flag is a true value, and when the flag is the true value, the server integrates the data element and the fingerprinting in the changed meta cache, and writes the data element and the fingerprinting into a main meta cache.

The above method not only can maintain the advantage of the data deduplication system, but also can reduce the processing load of the CPU and the memory, thereby reducing the time required for backup.

In another embodiment, the present invention contemplates a transaction-based system. The system includes a client and a server. The client transfers data for backup, the data comprising a plurality of data blocks. The server backs up the data. The server includes a meta cache and a main meta cache. The server sets a flag to determine whether to write at least one of the plurality of data blocks into the meta cache, and the server determines if a fingerprinting of the at least one of the plurality of data blocks is the same as originally stored in the meta cache, and the server writes the at least one or the plurality of data blocks into the meta cache if the fingerprinting is not the same. The server checks the flag and if the flag is set, the server writes the at least one or the plurality of data blocks into the main meta cache, and the server resets the flag.

A further embodiment comprehends a transaction-based system. The system includes a client and a server. The client transfers data for backup, the data comprising a plurality of data blocks. The server backs up the data. The server includes a meta cache, a main meta cache, and a hard disk. The server sets a flag to determine whether to write at least one of the plurality of data blocks into the meta cache, and the server determines if a fingerprinting of the at least one of the plurality of data blocks is the same as originally stored in the meta cache, and the server writes the at least one or the plurality of data blocks into the meta cache if the fingerprinting is not the same. The server checks the flag and if the flag is set, the server writes the at least one or the plurality of data blocks into the main meta cache, and the server resets the flag. After a complete data set is received, contents of the main meta cache are written to the hard disk.

### BRIEF DESCRIPTION OF THE DRAWINGS

FIG. 1 is a schematic view of a hardware structure according to a first embodiment of the disclosure;

FIG. 2 is a view showing data flow directions of FIG. 1;

FIG. 3 is a flow chart of FIG. 1;

FIG. 4 is a detailed flow chart of FIG. 1;

FIG. 5 is a flow chart of Step S620 of FIG. 4;

FIG. 6 is a flow chart of a second embodiment of the disclosure;

FIG. 7 is a flow chart of a third embodiment of the disclosure; and

FIG. 8 is a flow chart of a fourth embodiment of the disclosure.

### DETAILED DESCRIPTION OF THE INVENTION

The detailed features and advantages of the disclosure are described below in great detail through the following embodiments, and the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

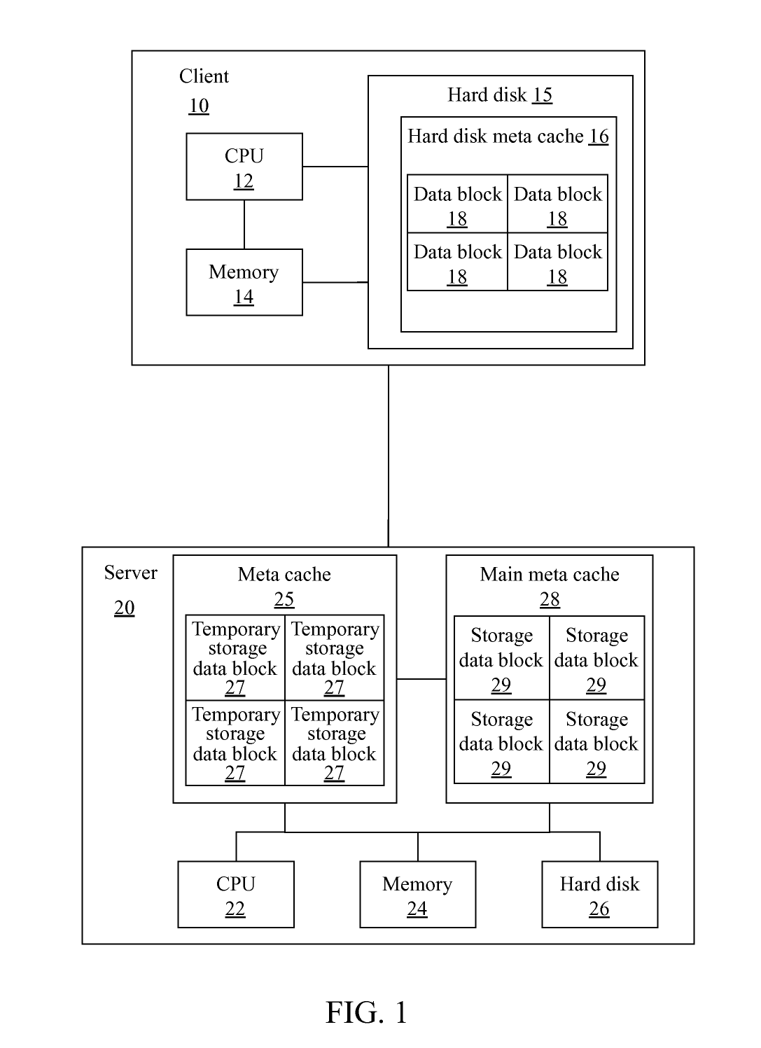

The disclosure is a processing method of a transaction-based system. FIG. 1 is a schematic view of a hardware structure according to an embodiment of the disclosure. In this embodiment, a client 10 is connected to a server 20, and data is transferred from the client 10 to the server 20. The client 10 comprises therein a CPU 12, a memory 14, a hard disk 15 and a hard disk meta cache 16. During data backup, data in the hard disk 15 is read, divided into a plurality of blocks of data through the CPU 12 and the memory 14, and then put into data blocks 18. The data blocks 18 are put into the hard disk meta cache 16.

As shown in FIG. 1, the server 20 comprises a CPU 22, a memory 24, a hard disk 26, a meta cache 25 and a main meta cache 28. In the server 20, the CPU 22 and the memory 24 control receiving and distribution of data. The received data is first written into a temporary storage data block 27 of the meta cache 25 corresponding to the client 10, and then is written to storage data blocks 29 in the main meta cache 28 after integration, and after a complete set of data is received, the data is written into the hard disk 26.

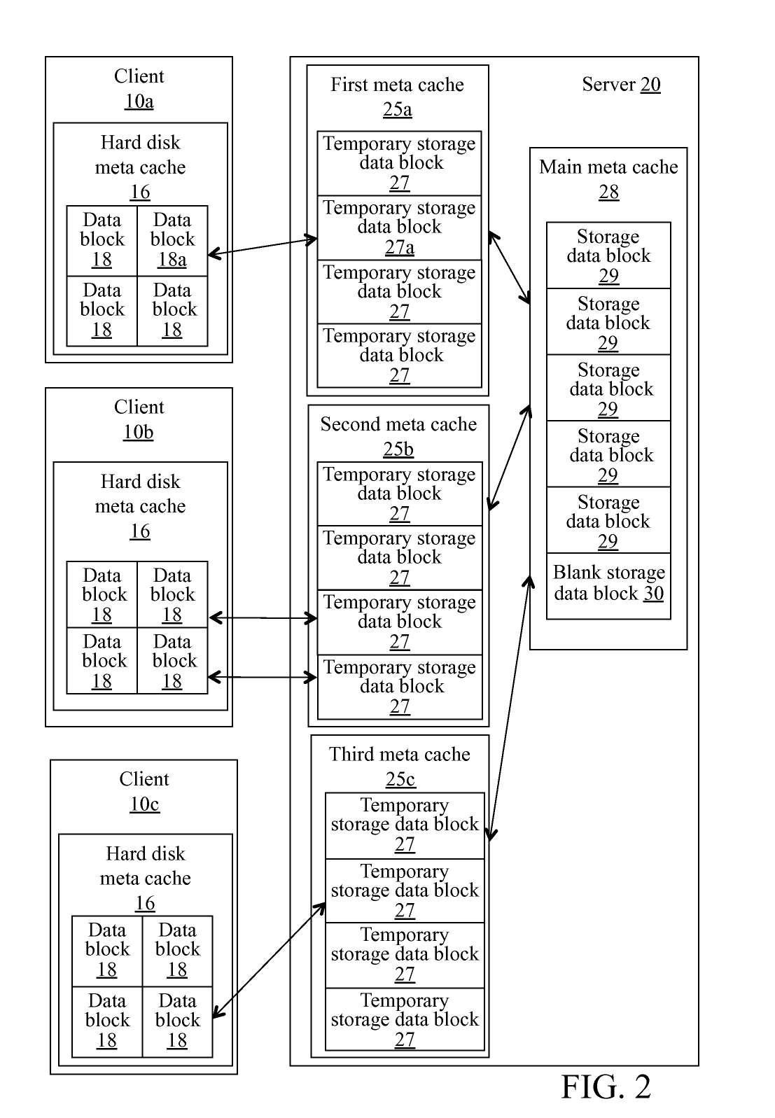

For a detailed method for writing data, reference can be made to FIG. 2, which is a view showing data flow directions of FIG. 1. It can be seen from FIG. 2 that the disclosure may be used to process multiple clients 10a, 10b and 10c, and to receive at least one data block 18. The clients 10a, 10b and 10c respectively have meta caches 25a, 25b and 25c corresponding to the clients 10a, 10b and 10c. When the server 20 intends to receive a data block 18a of a first client 10a, the server 20 first finds a first meta cache 25a corresponding to the first client 10a, and then writes the data block 18a into a temporary storage data block 27a corresponding to the data block 18a. As shown in FIG. 2, the meta caches 25a, 25b and 25c receive the data blocks 18 of the clients 10a, 10b and 10c, and after integration, the meta caches 25a, 25b and 25c are written into storage data blocks 29 in the main meta cache 28.

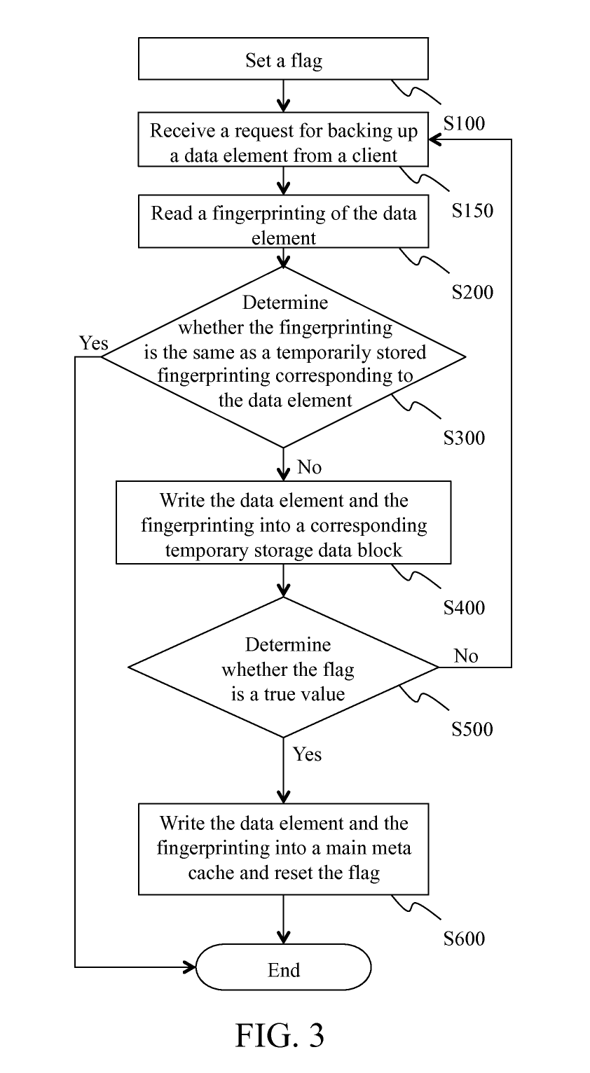

FIG. 3 is a detailed flow chart of an implementation of FIG. 1. First, the server 20 sets a flag (S100), in which the server 20 uses the flag to determine whether to write content of the meta cache 25 into the main meta cache 28. After the server 20 receives a request for backing up a data element sent by the client 10 (S150), the server 20 first reads a fingerprinting of the data element (S200). The server 20 determines whether the fingerprinting is the same as a temporary fingerprinting corresponding to the data element (S300). The temporary fingerprinting is located in a temporary storage data block 27 of the meta cache 25. That is to say, the temporary fingerprinting is a fingerprinting originally stored in the meta cache 25, and has been backed up. As the fingerprinting of the data element has similar characteristics to those of a human's fingerprint, and different data elements have different fingerprintings, it may be determine whether two data elements are the same according to the fingerprintings thereof. When the two data elements are the same, the server 20 does not need to write the data element repeatedly. When the server 20 determines that the fingerprinting is not the same as the temporary fingerprinting, the server 20 writes the data element and the fingerprinting into the corresponding temporary storage data block 27 (S400). In the disclosure, the step of determining whether the fingerprinting is the same as the temporary fingerprinting corresponding to the data element (S300) is determining whether the fingerprintings already exist in a set of the temporary fingerprintings by a bloom filter.

The method may be used to receive at least one data element of the multiple clients 10a, 10b and 10c, and may also be used to receive multiple data elements. The above Step S100 to Step S400 of receiving the request for backing up the data element from the client 10 by the server 20 may be executed repeatedly according the amount of the received data elements.

After executing the above Step S100 to Step S400, the server 20 first determines whether the flag is a true value (S500). As the server 20 uses the flag to determine whether to write the content of the meta cache 25 into the main meta cache 28, the server 20 writes the data element and the fingerprinting into the main meta cache 28 and resets the flag when the flag is the true value (S600). The flag is reset so that the server 20 can re-determine a next time point for writing the meta cache 25 into the main meta cache 28.

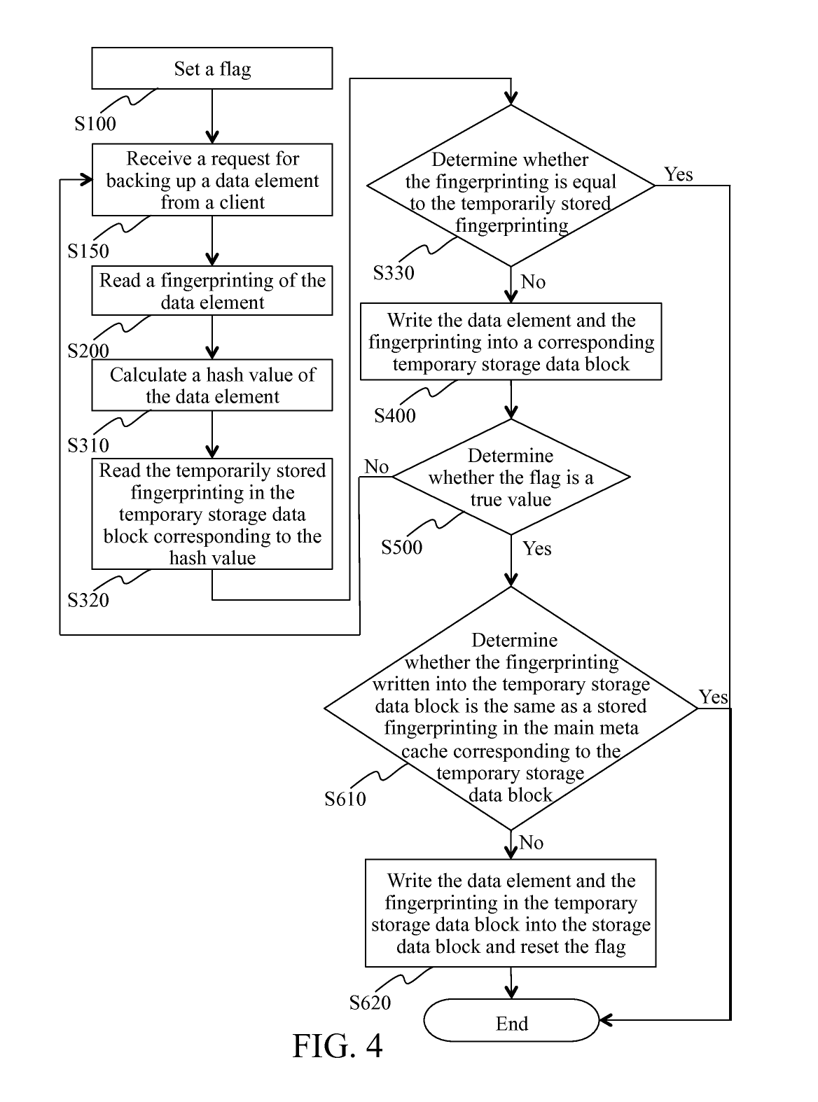

In order to make the disclosure more comprehensible, Step S300 of determining whether the fingerprinting is the same as the temporary fingerprinting corresponding to the data element may be illustrated in further detail. FIG. 4 is a detailed flow chart of the method of FIG. 1. In order to determine whether the fingerprinting is the same as the temporary fingerprinting corresponding to the data element (S300) to achieve data deduplication, the server 20 should first calculate a hash value of the data element (S310). The hash value is used to indicate a location of the data element. Therefore, after the hash value of the data element is obtained, the location of the data element in the meta cache 25 can be obtained. The hash value of the data element may be obtained through calculation based on the fingerprinting.

After obtaining the hash value of the data element, the server 20 can read the temporary fingerprinting in the temporary storage data block 27 corresponding to the hash value (S320). When the temporary storage data block 27 corresponding to the hash value does not have the temporary fingerprinting, the server 20 may directly write the data element and the fingerprinting corresponding to the hash value into the temporary storage data block 27. After obtaining the fingerprinting of the data element and the corresponding temporary fingerprinting, the server 20 can determine whether the fingerprinting is equal to the temporary fingerprinting (S330).

Further, referring to FIG. 4, Step S600 of writing the data element and the fingerprinting into the main meta cache 28 and resetting the flag may be further divided into: determining whether the fingerprinting written into the temporary storage data block 27 is the same as a stored fingerprinting in the main meta cache 28 corresponding to the temporary storage data block 27 (Step S610) and writing the data element and the fingerprinting in the temporary storage data block 27 into a storage data block 29 (Step S620). Each fingerprinting stored into the temporary storage data block 27 respectively corresponds to the stored fingerprinting in the main meta cache 28. Similar to the comparison between the fingerprinting and the temporary fingerprinting, when the fingerprinting stored into the temporary storage data block 27 is the same as the stored fingerprinting in the main meta cache 28, the server 20 does not need to re-store the corresponding temporary data element. When the fingerprinting stored into the temporary storage data block 27 is not the same as the stored fingerprinting in the main meta cache 28, it indicates that the data element of the temporary storage data block 27 is different from the data element stored in the main meta cache 28, and at this time, the server 20 should write the data element and the fingerprinting in the temporary storage data block 27 into the storage data block 29 (S620).

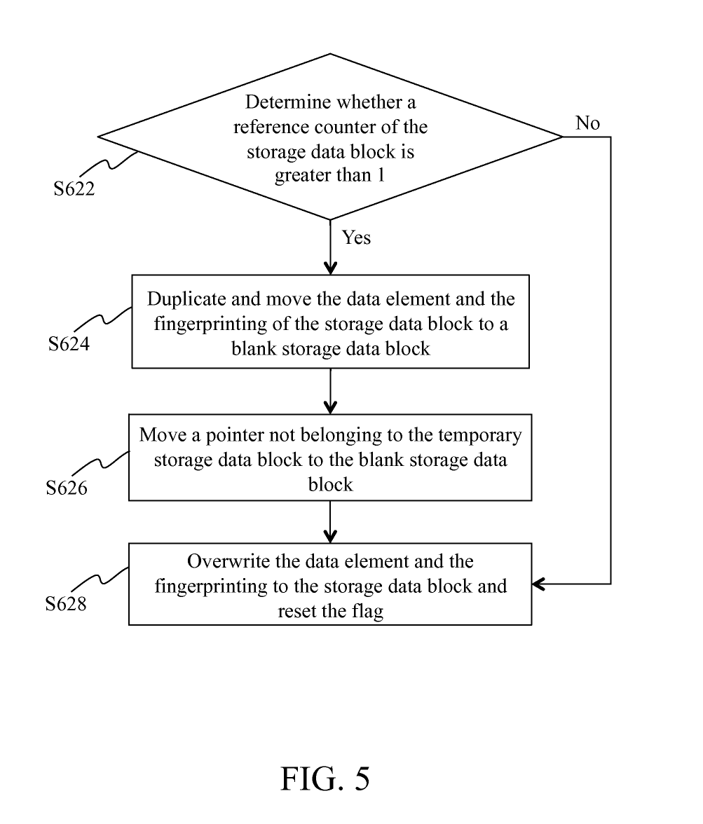

FIG. 5 is a flow chart of Step S620 of FIG. 4. When the server 20 writes the data element and the fingerprinting in the temporary storage data block 27 into the storage data block 29 (S620), the server 20 first determines whether a reference counter of the storage data block 29 is greater than 1 (S622). The reference counter is used to calculate the number of the temporary storage data blocks 27 pointing to the storage data block 29. When the data element of the client 10 is changed, data elements of other clients 10 are not necessarily changed. Therefore, when the server 20 intends to write the modified data element and fingerprinting into the storage data block 29, it should be considered whether other temporary storage data blocks 27 also point to the storage data block 29. If other temporary storage data blocks 27 also point to the storage data block 29, the server 20 needs to duplicate and move the data element and the fingerprinting of the storage data block 29 to a blank storage data block 30 (S624), so as to save original data of other temporary storage data blocks 27. The blank storage data block 30 is a storage data block 29 that is blank. After the data element and the fingerprinting of the storage data block 29 is duplicated and moved, a pointer not belonging to the temporary storage data block 27 should be first moved to the blank storage data block 30 (S626). The blank storage data block 30 is the same as the blank storage data block 30 in Step S624 of duplicating and moving the data element and the fingerprinting of the storage data block 29 to the blank storage data block 30. After Step S624 of duplicating and moving the data element and the fingerprinting of the storage data block 29 to the blank storage data block 30, content of the blank storage data block 30 becomes the data of the storage data block 29. Step S626 of moving a pointer not belonging to the temporary storage data block 27 to the blank storage data block 30 is moving pointers of other storage data blocks 27 that are not modified and pointers pointing to the original storage data block 29 to a new storage data block 29. In this manner, after the main meta cache 28 saves the original data in other temporary storage data blocks 27, the server 20 may overwrite the data element and the fingerprinting into the storage data block 29 and reset the flag (S628).

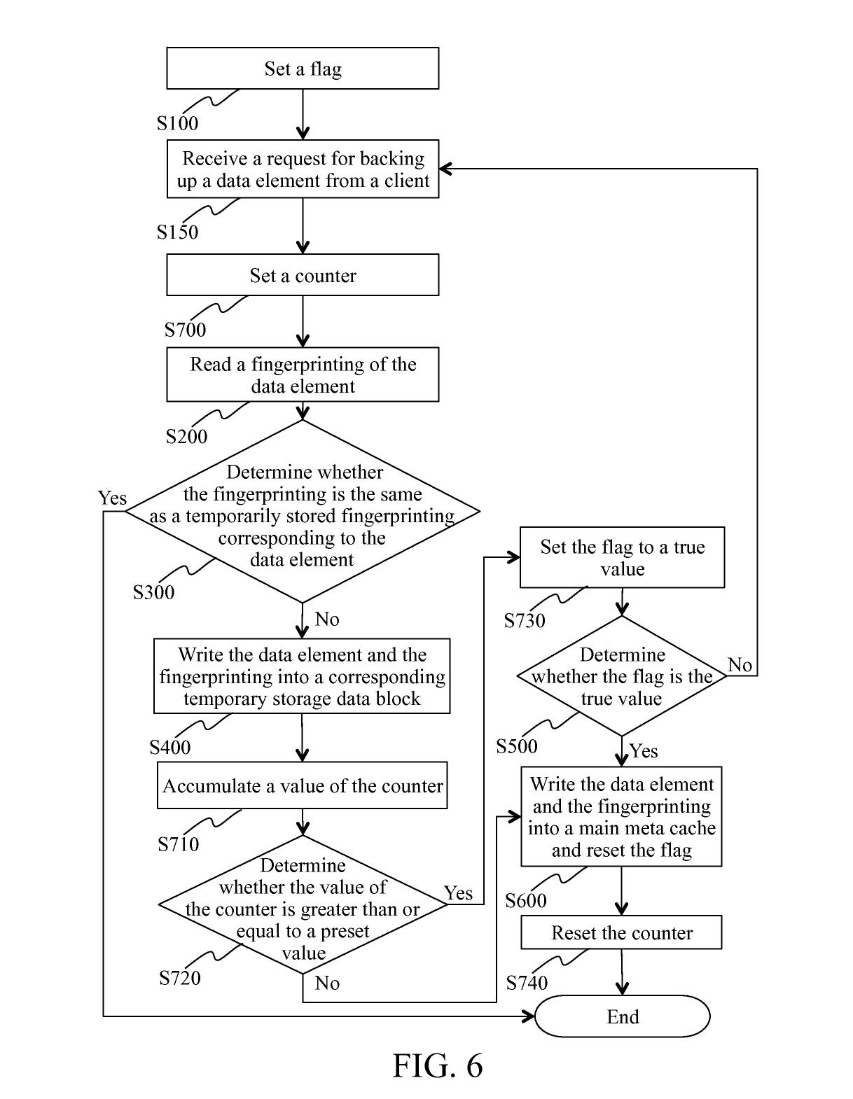

FIG. 6 is a flow chart of a second embodiment of the disclosure. In the second embodiment of the disclosure, the server 20 first resets a counter (S700). The counter is used to count the number of times that the server 20 writes the received data element into the meta cache 25. Each time after the server 20 writes the data element and the fingerprinting into the corresponding temporary storage data block 27 (S400), the server 20 automatically accumulates a value of the counter (S710). Then, the server 20 determines whether the value of the counter is greater than or equal to a preset value (S720). When the value of the counter is greater than or equal to the preset value, the server 20 sets the flag to a true value (S730). The preset value is a number set by the server 20, and may be a natural number such as 5 or 10. The number of the preset value may be any number, and is not limited by the content disclosed in this embodiment. Then, after Step S600, the value of the counter is reset (S740).

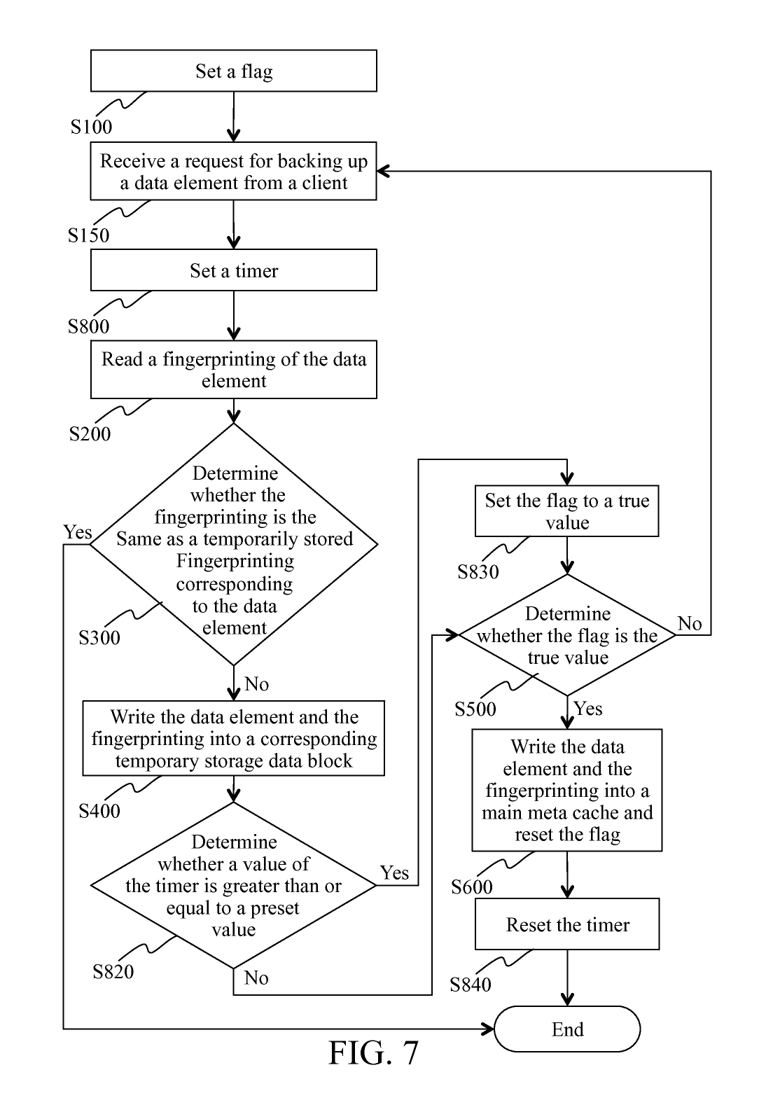

FIG. 7 is a flow chart of a third embodiment of the disclosure, wherein the same reference numbers mean the same processes mentioned above. In the third embodiment of the disclosure, the server 20 first resets a timer (S800). The timer times a duration of time. After Step S400 of writing the data element and the fingerprinting into the corresponding temporary storage data block 27, the server 20 determines whether a value of the timer is greater than or equal to a preset value (S820). When the value of the timer is greater than or equal to the preset value, the server 20 sets the flag to a true value (S830). The preset value is a time length set by the server 20, and may be a time length such as 5 seconds or 10 seconds. The time length of the preset value may be any number, and is not limited by the content disclosed in this embodiment. Then, after Step S600, the timer is reset (S840).

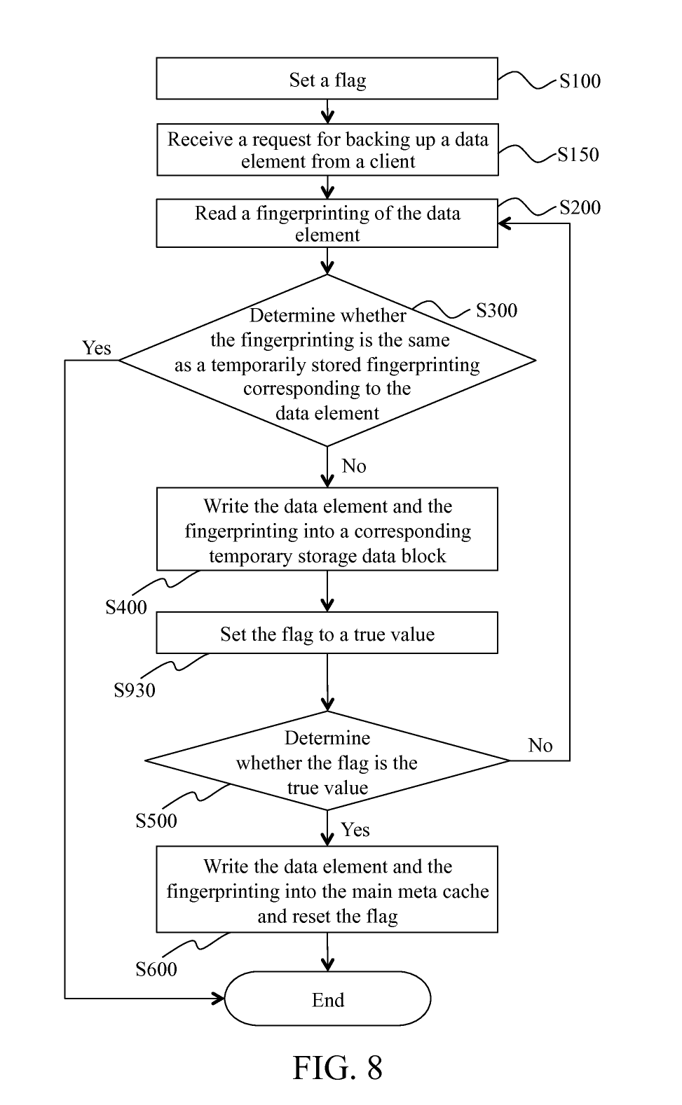

FIG. 8 is a flow chart of a fourth embodiment of the disclosure, wherein the same reference numbers mean the same processes mentioned above. After Step S400 of writing the data element and the fingerprinting into the corresponding temporary storage data block 27, the server 20 directly sets the flag to a true value (S930). That is to say, as long as one temporary data element is changed, the flag is set to the true value. Therefore, even when only one temporary data element is changed, the server 20, after determining whether the flag is the true value (S500), executes Step S600 of writing the data element and the fingerprinting into a main meta cache 28 and resetting the flag. The above second embodiment, third embodiment and fourth embodiment may be used at the same time, that is, the counter, timer and flag may be used at the same time to determine whether the temporary data element is changed.

Based on the above, the disclosure provides a processing method of a transaction-based system, which can provide a method to reduce the processing load of the CPU and the memory in the data deduplication system, so that not only the space required for backup can be reduced, but also the time and cost required for backup can be greatly reduced.

What is claimed is:

1. A processing method of a transaction-based system, comprising:
setting a flag;
performing the following steps after receiving at least one request for backing up a data element from multiple clients:
reading a fingerprinting of the data element;
determining whether the fingerprinting is the same as a temporary fingerprinting corresponding to the data element; and
writing the data element and the fingerprinting into a corresponding temporary data block when the fingerprinting is not the same as the temporary fingerprinting;
determining whether the flag is a true value; and
writing the data element and the fingerprinting into a main meta cache and resetting the flag when the flag is the true value.

2. The processing method of the transaction-based system according to claim 1, wherein the step of determining whether the fingerprinting is the same as the temporary fingerprinting corresponding to the data element comprises the following steps:
calculating a hash value of the data element;
reading the temporary fingerprinting in the temporary storage data block corresponding to the hash value; and
determining whether the fingerprinting is equal to the temporary fingerprinting.

3. The processing method of the transaction-based system according to claim 2, wherein the data element and the fingerprinting corresponding to the hash value are written into the temporary data block, when the temporary storage data block corresponding to the hash value does not have the temporary fingerprinting.

4. The processing method of the transaction-based system according to claim 2, wherein the step of determining whether the fingerprintings are the same as the temporary fingerprintings is determining whether the fingerprintings already exist in a set of the temporary fingerprintings by a bloom filter.

5. The processing method of the transaction-based system according to claim 1, wherein the step of writing the data element and the fingerprinting into a main meta cache and resetting the flag comprises:
determining whether the fingerprinting written into the temporary storage data block is the same as a stored fingerprinting of a storage data block corresponding to the temporary storage data block in the main meta cache; and
writing the data element and the fingerprinting in the temporary storage data block into the storage data block when the fingerprinting written into the temporary storage data block is not the same as the corresponding stored fingerprinting.

6. The processing method of the transaction-based system according to claim 5, wherein the step of writing the data element to be backed up in the temporary storage data block and the fingerprinting in the temporary storage data block into the storage data block comprises the following steps:
determining whether a reference counter of the storage data block is greater than 1;
duplicating and moving the data element and the fingerprinting of the storage data block to a blank storage data block when the reference counter of the storage data block is greater than 1;
moving a pointer not belonging to the temporary storage data block to the blank storage data block when the reference counter of the storage data block is greater than 1; and
overwriting the data element and the fingerprinting to the storage data block and resetting the flag.

7. The processing method of the transaction-based system according to claim 1, wherein before the step of performing the following steps after receiving at least one request for backing up the data element, the method comprises:
setting a counter;
after the step of writing the data element and the fingerprinting into the corresponding temporary storage data block when the fingerprinting is not the same as the temporary fingerprinting, the method comprises: accumulating a value of the counter;
before the step of determining whether the flag is the true value, the method comprises: determining whether the value of the counter is greater than or equal to a preset value and setting the flag to the true value when the value of the counter is greater than or equal to the preset value; and
after the step of writing the data element and the fingerprinting into a main meta cache and resetting the flag when the flag is the true value, the method comprises: the counter is reset.

8. The processing method of the transaction-based system according to claim 1, wherein before the step of performing the following steps after receiving at least one request for backing up a data element, the method comprises:
setting a timer;
before the step of determining whether the flag is the true value, the method comprises: determining whether a value of the timer is greater than or equal to a preset value, and setting the flag to the true value when the value of the timer is greater than or equal to the preset value; and
after the step of writing the data element and the fingerprinting into the main meta cache and resetting the flag when the flag is the true value, the method comprises: the timer is reset.

9. The processing method of the transaction-based system according to claim 1, wherein after the step of writing the data element and the fingerprinting into the corresponding temporary storage data block when the fingerprinting is not the same as the temporary fingerprinting, the method comprises: the flag is set to the true value.

10. A transaction-based system, comprising:
a client, that transfers data for backup, said data comprising a plurality of data blocks; and
a server, that backs up said data, said server comprising:
a meta cache, wherein said server sets a flag to determine whether to write at least one of said plurality of data blocks into said meta cache, and wherein said server determines if a fingerprinting of said at least one of said plurality of data blocks is the same as originally stored in said meta cache, and wherein said server writes said at least one or said plurality of data blocks into said meta cache if said fingerprinting is not the same; and
a main meta cache, wherein said server checks said flag and if said flag is set, said server writes said at least one or said plurality of data blocks into
said main meta cache, and wherein said server resets said flag.

11. The transaction-based system as recited in claim 10, wherein said server determines if said fingerprinting of said at least one of said plurality of data blocks is the same as originally stored in said meta cache by calculating a hash value.

12. The transaction-based system as recited in claim 10, wherein said server determines if said fingerprinting of said at least one of said plurality of data blocks is the same as originally stored in said meta cache by employing a bloom filter.

13. The transaction-based system as recited in claim 10, wherein said server writes said at least one of said plurality of data blocks along with said fingerprinting into said meta cache by performing the following steps:
determining whether a reference counter of a storage data block is greater than 1;
duplicating and moving said at least one of said plurality of data blocks and said fingerprinting of said storage data block to a blank storage data block when said reference counter of said storage data block is greater than 1;
moving a pointer not belonging to a temporary storage data block to said blank storage data block when said reference counter of said storage data block is greater than 1; and
overwriting said at least one of said plurality of data blocks and said fingerprinting to said storage data block and resetting said flag.

14. The processing method of the transaction-based system according to claim 10, wherein, upon receipt of a request for backing up of said at least one of said plurality of data blocks, said server sets a counter and increments said counter when said at least one of said plurality of data blocks is written into said meta cache, and wherein when said counter is greater or equal to a preset value said server writes said at least one of said plurality of data elements and said fingerprinting into said main meta cache and resets said flag.

15. The processing method of the transaction-based system according to claim 10, wherein, upon receipt of a request for backing up of said at least one of said plurality of data blocks, said server activates a timer, and wherein when said timer is greater or equal to a preset value said server writes said at least one of said plurality of data elements and said fingerprinting into said main meta cache and resets said flag.

16. A transaction-based system, comprising:
a client, that transfers data for backup, said data comprising a plurality of data blocks; and
a server, that backs up said data, said server comprising:
a meta cache, wherein said server sets a flag to determine whether to write at least one of said plurality of data blocks into said meta cache, and wherein said server determines if a fingerprinting of said at least one of said plurality of data blocks is the same as originally stored in said meta cache, and wherein said server writes said at least one or said plurality of data blocks into said meta cache if said fingerprinting is not the same;
a main meta cache, wherein said server checks said flag and if said flag is set, said server writes said at least one or said plurality of data blocks into said main meta cache, and wherein said server resets said flag; and
a hard disk, wherein after a complete data set is received, contents of said main meta cache are written to said hard disk.

17. The transaction-based system as recited in claim 16, wherein said server determines if said fingerprinting of said at least one of said plurality of data blocks is the same as originally stored in said meta cache by calculating a hash value.

18. The transaction-based system as recited in claim 16, wherein said server determines if said fingerprinting of said at least one of said plurality of data blocks is the same as originally stored in said meta cache by employing a bloom filter.

19. The processing method of the transaction-based system according to claim 16, wherein, upon receipt of a request for backing up of said at least one of said plurality of data blocks, said server sets a counter and increments said counter when said at least one of said plurality of data blocks is written into said meta cache, and wherein when said counter is greater or equal to a preset value said server writes said at least one of said plurality of data elements and said fingerprinting into said main meta cache and resets said flag.

20. The processing method of the transaction-based system according to claim 16, wherein, upon receipt of a request for backing up of said at least one of said plurality of data blocks, said server activates a timer, and wherein when said timer is greater or equal to a preset value said server writes said at least one of said plurality of data elements and said fingerprinting into said main meta cache and resets said flag.
